(19) United States
(12) Patent Application Publication
(10) Pub. No.: US 2026/0120953 A1
(43) Pub. Date: Apr. 30, 2026

(54) CAPACITOR

(71) Applicant: Panasonic Intellectual Property Management Co., Ltd., Osaka (JP)

(72) Inventors: SHUHEI YOKOTA, Toyama (JP); HIDEKI KATAYAMA, Toyama (JP); TORU MASAMOTO, Toyama (JP)

(21) Appl. No.: 19/004,066

(22) Filed: Dec. 27, 2024

(30) Foreign Application Priority Data
Jan. 16, 2024 (JP) 2024-004635

(51) Int. Cl. H01G 4/228; H01G 4/224

(52) U.S. Cl. CPC H01G 4/228; H01G 4/224

(57) ABSTRACT

A capacitor includes: a capacitor element that includes a first electrode disposed on one end surface of the capacitor element, a second electrode disposed on another end surface of the capacitor element, and a circumferential surface connecting the first electrode to the second electrode; a first bus bar and a second bus bar that are connected to the first electrode and the second electrode, respectively; a case that houses the capacitor element; and a filler resin in which the capacitor element, a part of the first bus bar, and a part of the second bus bar are embedded, the filler resin being filled inside the case. The circumferential surface includes a plane face. The first bus bar includes an opposing portion that has a flat-plate-shape and faces the plane face. The opposing portion includes a protrusion that protrudes toward the plane face and abuts the plane face.

### BACKGROUND

### 1. Technical Field

The present disclosure relates to a capacitor.

### 2. Description of the Related Art

Unexamined Japanese Patent Publication No. 2018/051656, for example, describes a capacitor in which a capacitor element unit, formed by connecting a bus bar to electrodes of a capacitor element, is housed in a case and the case is filled with a filler resin, the capacitor being configured in a manner that the bus bar includes a portion that faces a circumferential surface of the capacitor element.

In the film capacitor of Unexamined Japanese Patent Publication No. 2018/051656, a lower bus bar includes a relay portion as a portion facing the circumferential surface of the capacitor element. The relay portion extends upward along the circumferential surface of the capacitor element from an end of a lower electrode terminal portion, which is connected to a lower end-face electrode of the capacitor element. A gap is formed between the circumferential surface of the capacitor element and the relay portion, and the filler resin enters the gap. The filler resin is injected into the case in a liquid-phase state and then cured inside the case. This results in the circumferential surface of the capacitor element and the relay portion being joined together by the filler resin.

### SUMMARY

A first aspect of the present disclosure relates to a capacitor. The capacitor according to the aspect includes: a capacitor element that includes a first electrode disposed on one end surface of the capacitor element, a second electrode disposed on another end surface of the capacitor element, and a circumferential surface connecting the first electrode to the second electrode; a first bus bar and a second bus bar that are connected to the first electrode and the second electrode, respectively; a case that houses the capacitor element; and a filler resin in which the capacitor element, a part of the first bus bar, and a part of the second bus bar are embedded, the filler resin being filled inside the case. Here, the circumferential surface includes a plane face. The first bus bar includes an opposing portion that has a flat-plate-shape and faces the plane face. The opposing portion includes a protrusion that protrudes toward the plane face and abuts the plane face.

According to the present disclosure, it is possible to provide a capacitor that can maintain a constant width of the gap between the circumferential surface of the capacitor element and the opposing portion of the bus bar facing the circumferential surface.

Effects or meanings of the present disclosure will be further clarified by the following description of exemplary embodiments. The exemplary embodiments described below are merely examples for implementing the present disclosure, and the present disclosure is not limited to the description in the following exemplary embodiments at all.

### BRIEF DESCRIPTION OF THE DRAWINGS

FIG. 1 is a perspective view illustrating a film capacitor according to a first exemplary embodiment;

FIG. 2 is a cross-sectional view illustrating the film capacitor according to the first exemplary embodiment, cut parallel to an XZ plane at a center in a Y-axis direction;

FIG. 3 is a perspective view illustrating a capacitor element module according to the first exemplary embodiment;

FIG. 4 is a perspective view illustrating the capacitor element module according to the first exemplary embodiment;

FIG. 5 is a cross-sectional view illustrating the capacitor element module according to the first exemplary embodiment, cut parallel to an XY plane at a position on a negative Z-axis side relative to an insulation member;

FIG. 6 is an exploded perspective view illustrating a first bus bar according to the first exemplary embodiment;

FIG. 7 is an exploded perspective view illustrating a second bus bar according to the first exemplary embodiment;

FIG. 8A is a cross-sectional view illustrating a main part of the first bus bar according to the first exemplary embodiment, cut at a position of a first junction, showing a portion near a first junction terminal portion;

FIG. 8B is a cross-sectional view illustrating a main part of the second bus bar according to the first exemplary embodiment, cut at a position of a second junction, showing a portion near a second junction terminal portion;

FIGS. 9A and 9B are perspective views illustrating the insulation member according to the first exemplary embodiment;

FIG. 10 is a perspective view illustrating a case according to the first exemplary embodiment;

FIG. 11 is a plan view illustrating the film capacitor according to the first exemplary embodiment, with external terminals joined to the first junction terminal portion and the second junction terminal portion;

FIG. 12 is a perspective view illustrating a film capacitor according to a second exemplary embodiment;

FIG. 13 is a perspective view illustrating the film capacitor according to the second exemplary embodiment; and

FIG. 14 is a plan view illustrating a capacitor element module according to the second exemplary embodiment.

### DETAILED DESCRIPTIONS OF EMBODIMENTS

Hereinafter, problems of the prior art will be briefly described.

In the film capacitor according to Unexamined Japanese Patent Publication No. 2018/051656, it is difficult to maintain a constant width of the gap between the circumferential surface of the capacitor element and the relay portion. Therefore, when the width of the gap becomes small, the thickness of the filler resin that has entered the gap decreases, and thus, peeling is more likely to occur between the circumferential surface and the filler resin or between the relay portion and the filler resin. Additionally, when the width of the gap becomes small, the liquid-phase filler resin does not sufficiently enter the gap, making it easier for cavities (voids) to occur within the cured filler resin that has entered the gap. Thus, there is a risk that moisture is more likely to enter peeled portions and cavities, reducing the moisture resistance of the film capacitor.

Therefore, the present disclosure provides a capacitor that can maintain a constant width of the gap between the circumferential surface of the capacitor element and an opposing portion of the bus bar facing the circumferential surface.

Hereinafter, a film capacitor according to an exemplary embodiment of a capacitor of the present disclosure will be described with reference to the drawings. For the sake of convenience, an X-axis, a Y-axis, and a Z-axis perpendicular to each other are added to the drawings.

### FIRST EXEMPLARY EMBODIMENT

Film capacitor 1 according to a first exemplary embodiment will be described. Film capacitor 1 is a so-called case-mold type capacitor.

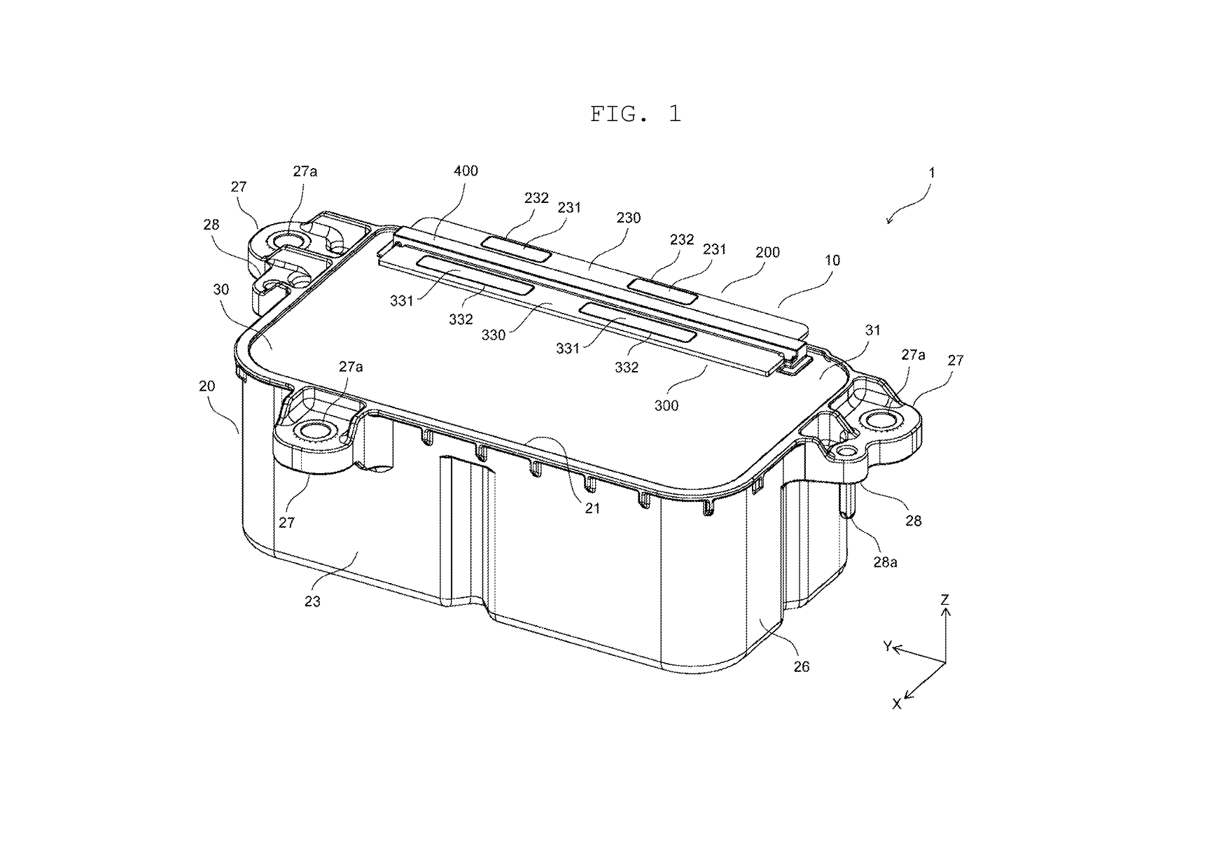

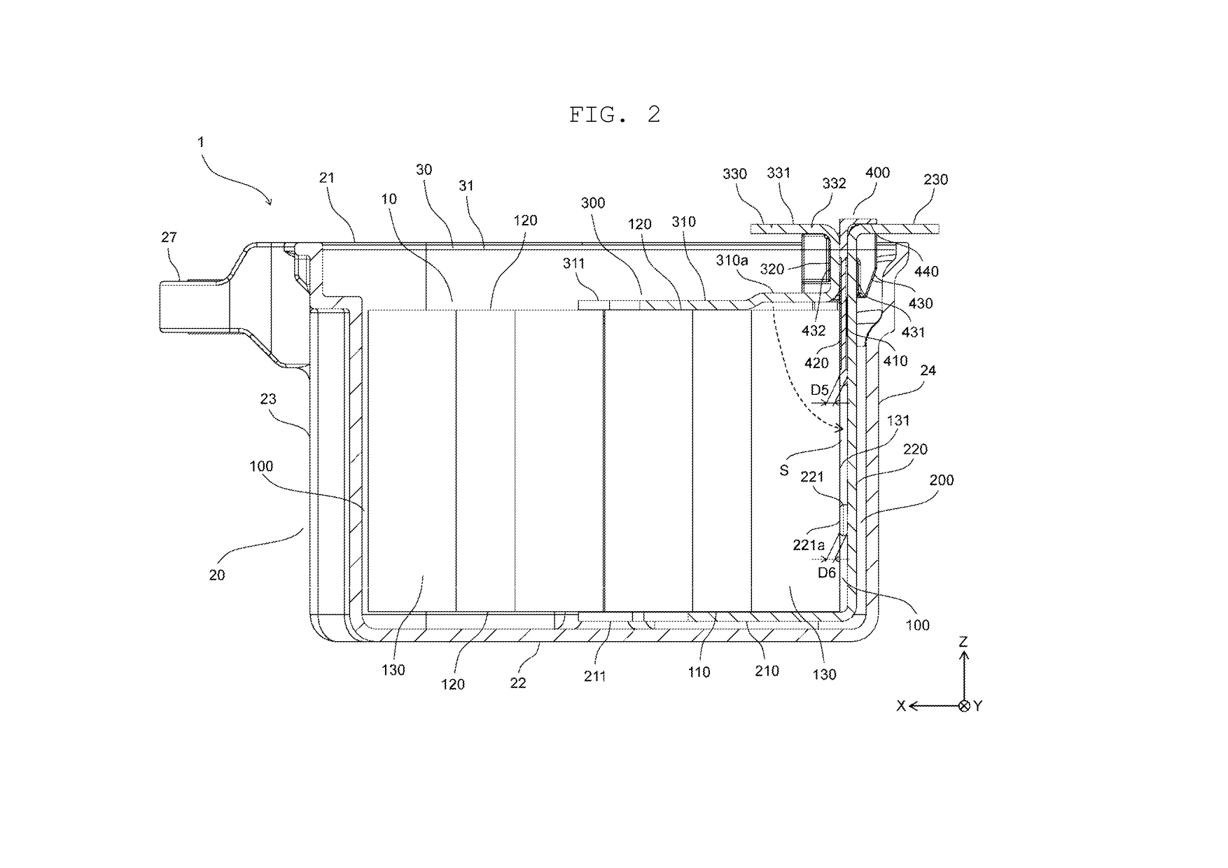

FIG. 1 is a perspective view of film capacitor 1. FIG. 2 is a cross-sectional view of film capacitor 1, cut parallel to an XZ plane at a center in a Y-axis direction. Note that in FIG. 2, for convenience, filler resin 30 is shown in a transparent state.

Film capacitor 1 includes capacitor element module 10, case 20, and filler resin 30. Capacitor element module 10 is housed in case 20, and case 20 is filled with filler resin 30.

Filler resin 30 is a thermosetting resin such as an epoxy resin. Filler resin 30 serves as an exterior body that covers capacitor element module 10 inside case 20. A portion of capacitor element module 10 embedded in filler resin 30 is protected from moisture and impact by case 20 and filler resin 30.

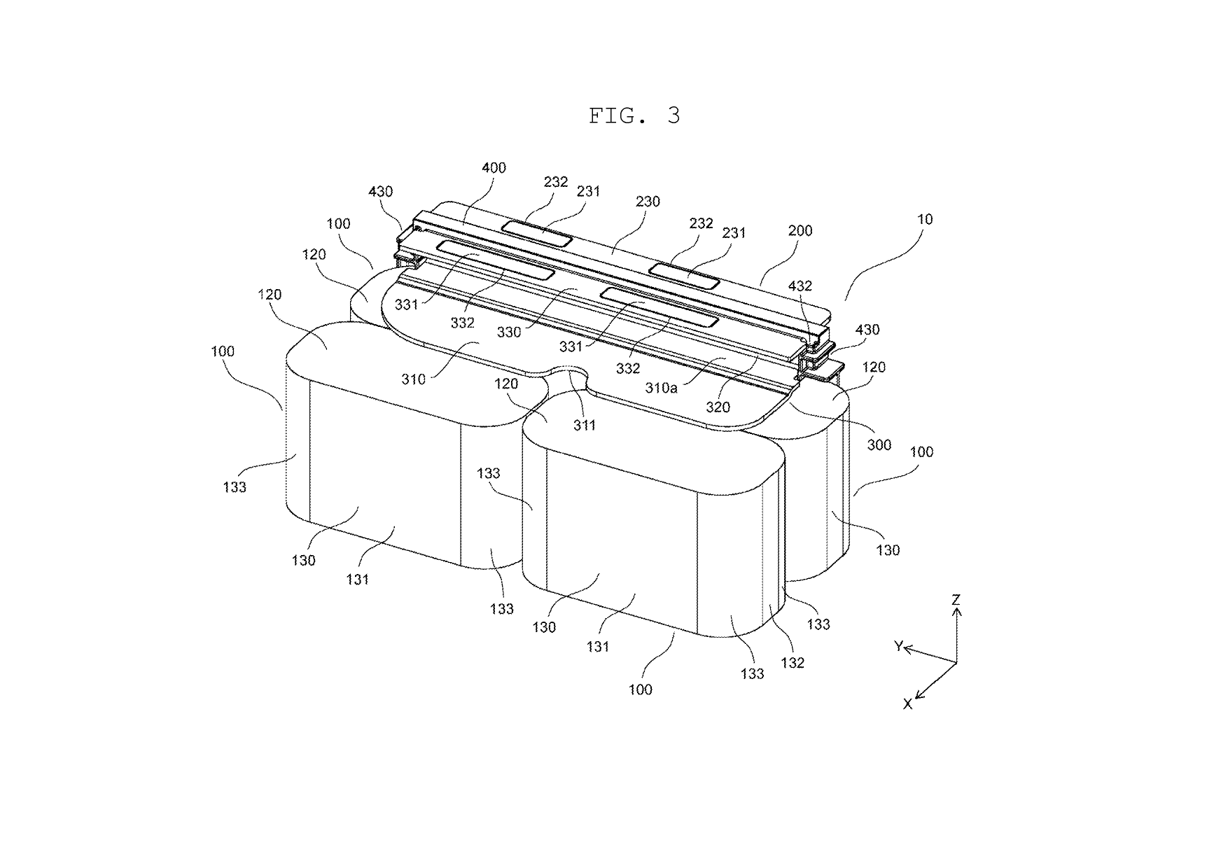

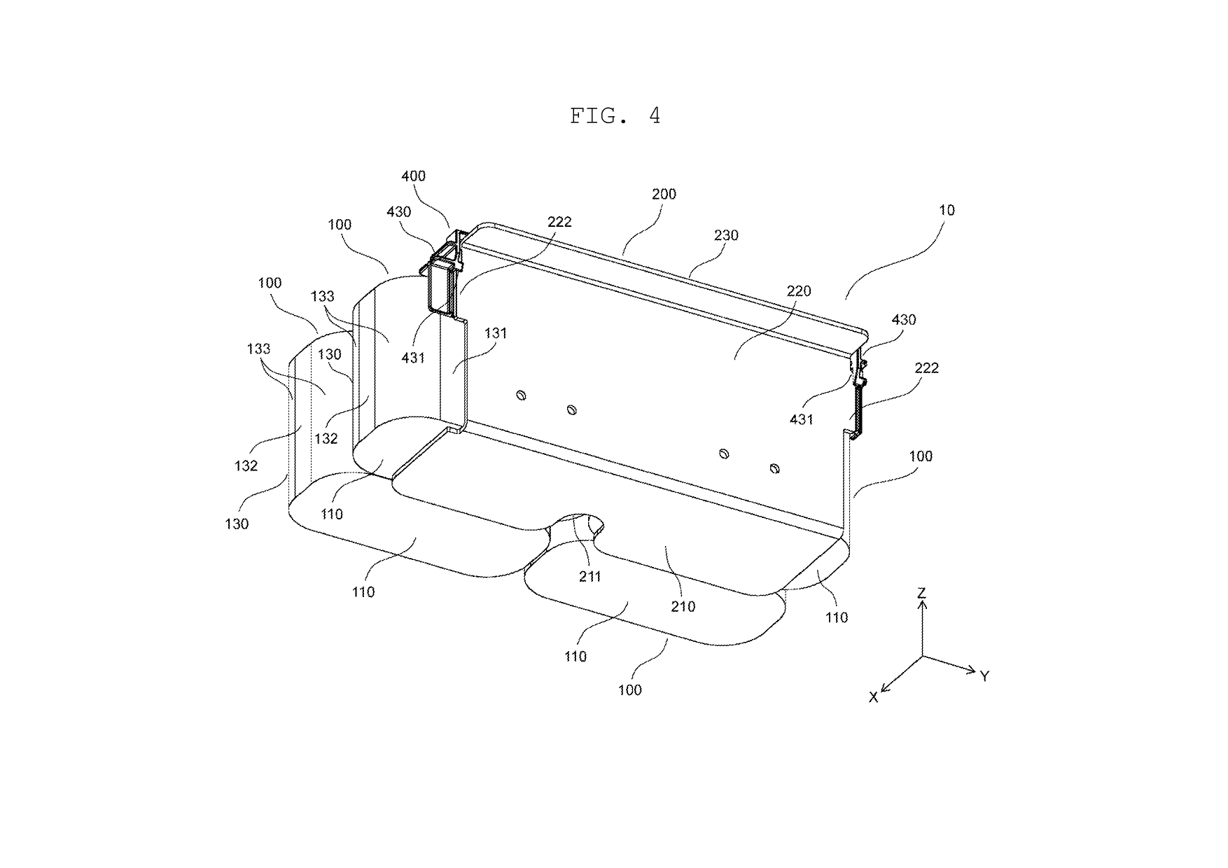

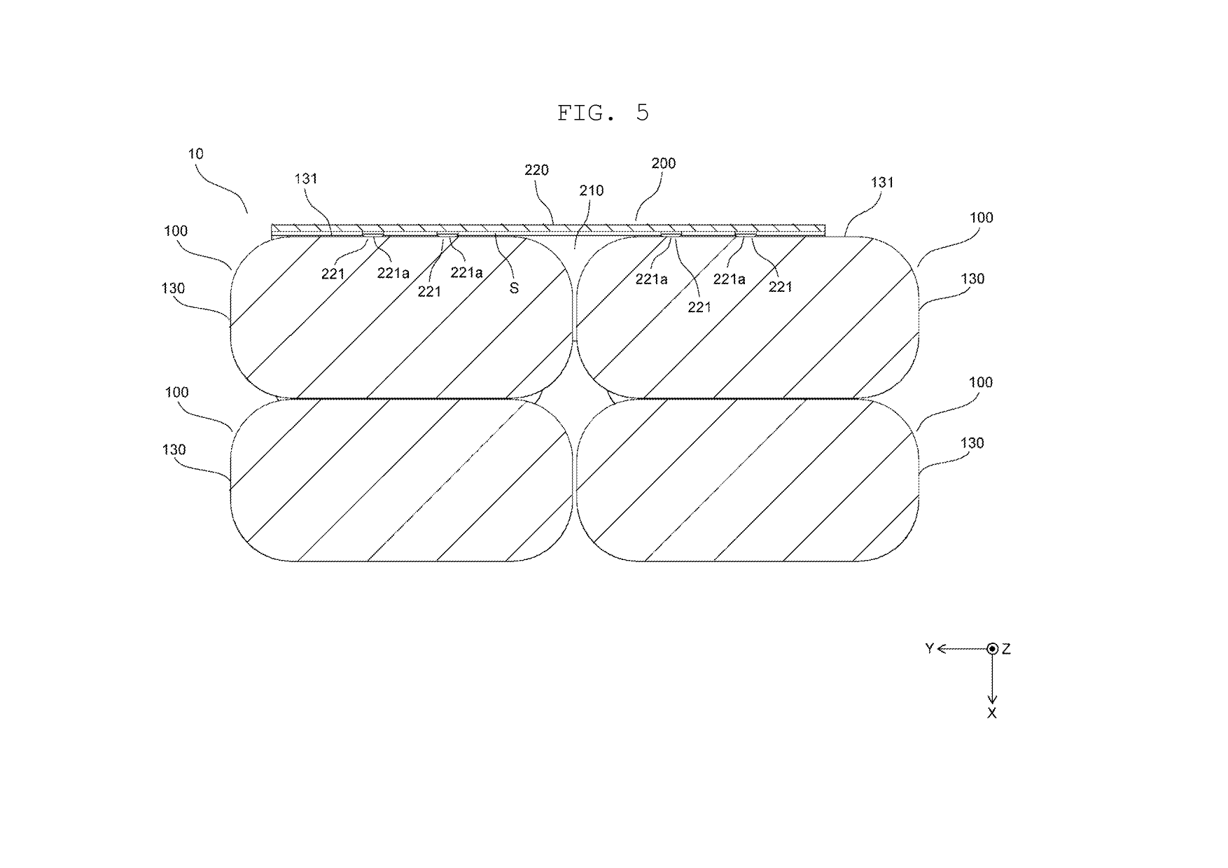

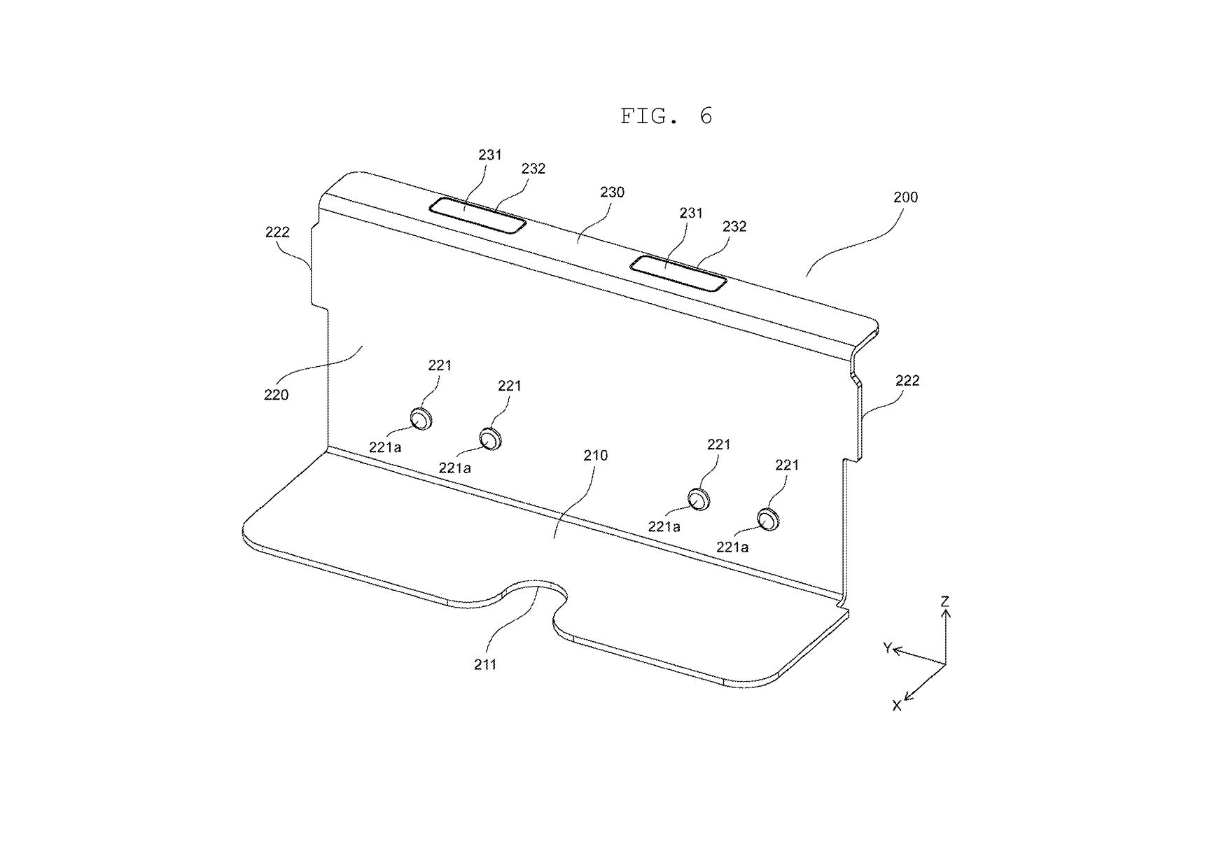

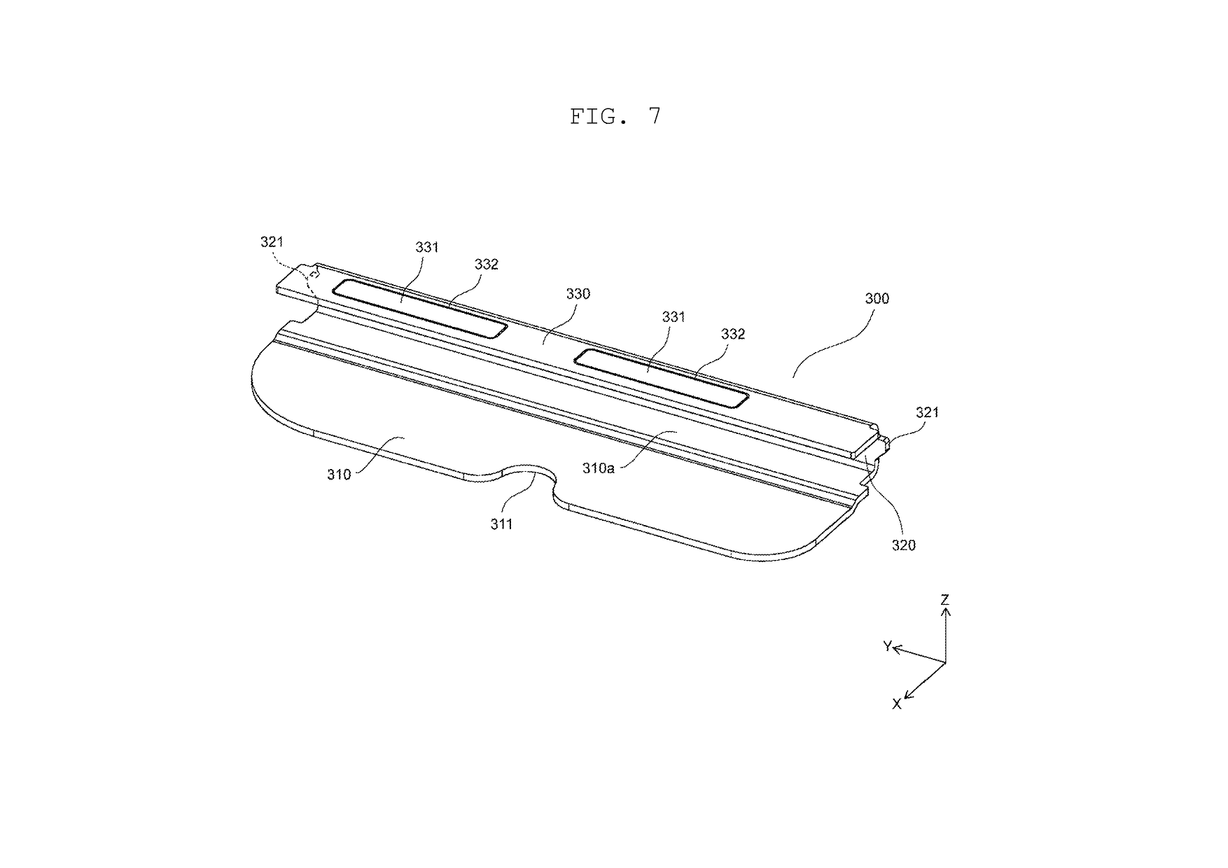

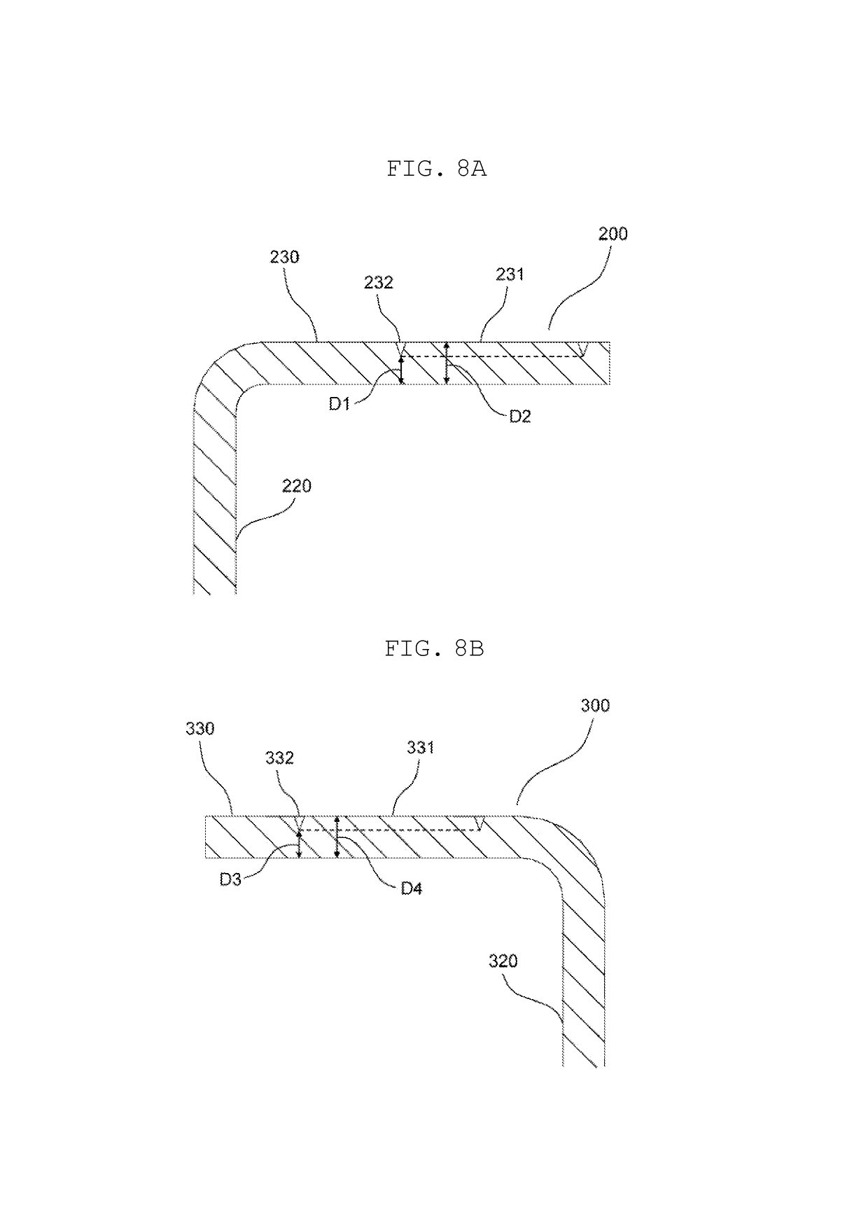

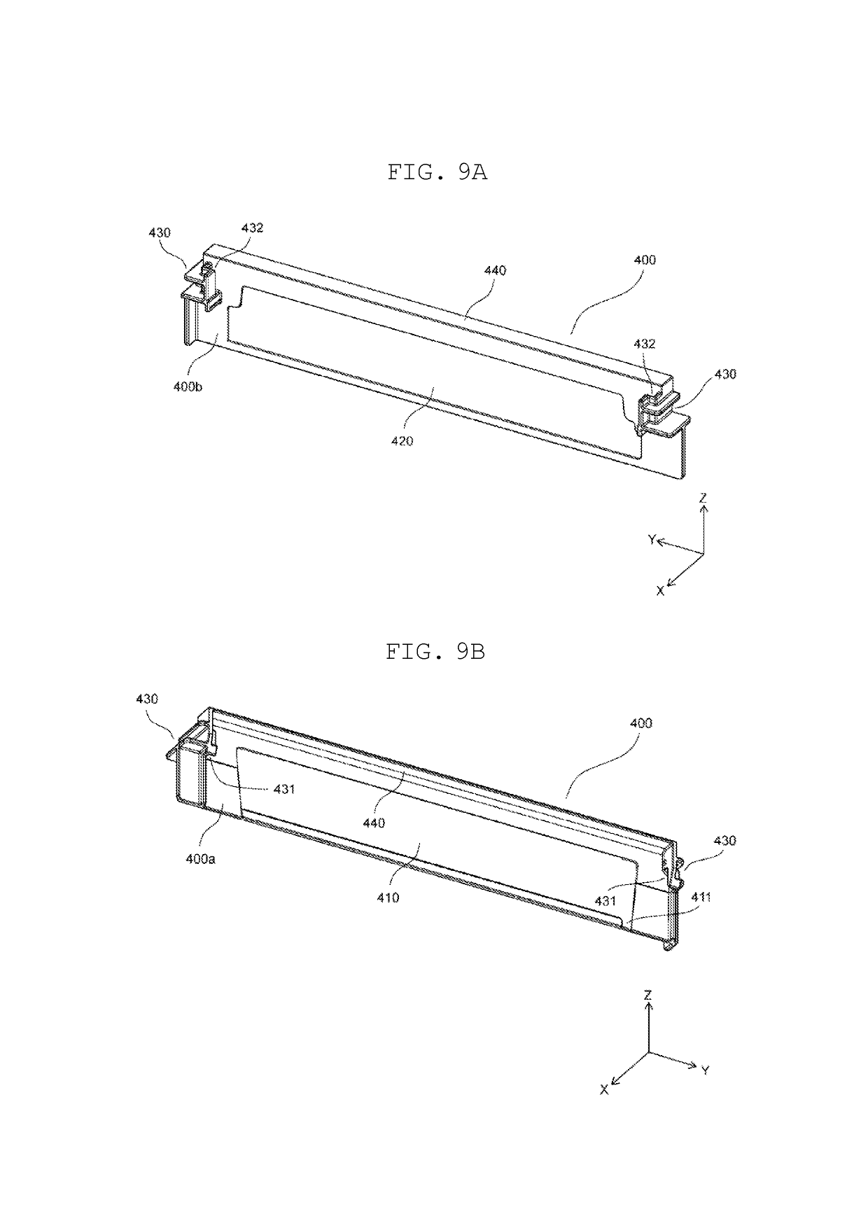

FIGS. 3 and 4 are perspective views of capacitor element module 10. FIG. 5 is a cross-sectional view of capacitor element module 10, cut parallel to an XY plane at a position on a negative Z-axis side relative to insulation member 400. FIG. 6 is a perspective view of first bus bar 200. FIG. 7 is a perspective view of second bus bar 300. FIG. 8A is a cross-sectional view of a main part of first bus bar 200, cut at a position of first junction 231, showing a portion near first junction terminal portion 230. FIG. 8B is a cross-sectional view of a main part of second bus bar 300, cut at a position of second junction 331, showing a portion near second junction terminal portion 330. FIGS. 9A and 9B are perspective views of insulation member 400.

Capacitor element module 10 includes four capacitor elements 100, first bus bar 200, second bus bar 300, and insulation member 400.

Capacitor element 100 is formed by stacking two metallized films each with aluminum vapor-deposited on a dielectric film, and winding or laminating the stacked metallized films, and pressing the stacked metallized films, thereby forming the stacked metallized films into a shape similar to a flattened oblong cylinder. In capacitor element 100, first electrode 110 is formed on one end surface by spraying metal such as zinc, and second electrode 120 is formed on another end surface by similarly spraying metal such as zinc.

Capacitor element 100 has circumferential surface 130 that connects first electrode 110 and second electrode 120. Circumferential surface 130 includes: two first plane faces 131 arranged in an X-axis direction, which is a lateral direction of capacitor element 100; two second plane faces 132 arranged in the Y-axis direction, which is a longitudinal direction of capacitor element 100; and four arc surfaces 133 located between first plane faces 131 and second plane faces 132. A dimension of first plane faces 131 in the Y-axis direction is larger than a dimension of second plane faces 132 in the X-axis direction.

Note that capacitor element 100 according to the present exemplary embodiment is formed of metallized films each with aluminum vapor-deposited on a dielectric film. In addition, capacitor element 100 may be formed of metallized films having another metal such as zinc or magnesium vapor-deposited. Alternatively, capacitor element 100 may be formed with metallized films made by having a plurality of metals of these metals vapor-deposited, or may be formed with metallized films made by having an alloy of these metals vapor-deposited.

Four capacitor elements 100 are arranged in two rows in both the X-axis direction and the Y-axis direction in a manner that circumferential surfaces 130 thereof face each other. In each capacitor element 100, first electrode 110 is oriented in the negative Z-axis direction, and second electrode 120 is oriented in the positive Z-axis direction.

First bus bar 200 is formed by cutting out, from a conductive material such as a copper plate, an appropriate shape followed by bending. First bus bar 200 is, therefore, a single structure including first electrode terminal portion 210, first relay portion 220, and first junction terminal portion 230.

First electrode terminal portion 210 has a substantially rectangular flat plate shape elongated in the Y-axis direction. The two corners of first electrode terminal portion 210 in the positive X-axis direction are formed into large arcs. At the end of first electrode terminal portion 210 in the positive X-axis direction, substantially U-shaped notch 211 is formed at a central portion.

First relay portion 220 provides a relay between first electrode terminal portion 210 and first junction terminal portion 230. First relay portion 220 has a substantially rectangular flat plate shape elongated in the Y-axis direction and extends perpendicularly to first electrode terminal portion 210 in the positive Z-axis direction from the end of first electrode terminal portion 210 in the negative X-axis direction. The dimension of first relay portion 220 in the Z-axis direction is larger than the dimension of capacitor element 100 in the Z-axis direction, that is, the direction in which first electrode 110 and second electrode 120 are arranged.

First relay portion 220 is provided with two protrusions 221 at two positions on the surface of the positive X-axis side, one on the positive Y-axis side and the other on the negative Y-axis side, each position being closer to first electrode terminal portion 210 than the center of the Z-axis direction, in a manner that two protrusions 221 are arranged in the Y-axis direction. Four protrusions 221 have a flat, substantially cylindrical shape and protrude in the positive X-axis direction from the surface of first relay portion 220 on the positive X-axis side. Distal end surface 221a of each protrusion 221 has a flat shape, and the outer peripheral edge of distal end surface 221a is chamfered into an arc shape. Furthermore, at the positive Y-axis side end and the negative Y-axis side end of first relay portion 220, near first junction terminal portion 230, first protrusion pieces 222 are formed, protruding in the positive Y-axis direction and the negative Y-axis direction, respectively.

First junction terminal portion 230 has a substantially rectangular flat plate shape elongated in the Y-axis direction and extends in the negative X-axis direction perpendicularly to first relay portion 220 from the end of first relay portion 220 in the positive Z-axis direction. On an inner portion of the surface of first junction terminal portion 230, first junctions 231 to which welding is performed when an external terminal is joined are provided at two positions arranged in the Y-axis direction. On the surface of first junction terminal portion 230, as a designation section indicating the region of each first junction 231, substantially rectangular annular first groove 232 is provided, which indicates a boundary between the region of each first junction 231 and other regions.

As shown in FIG. 8A, first groove 232 has, for example, a V-shaped cross-section. First groove 232 may have a cross-sectional shape other than V-shaped, such as semicircular, U-shaped, or rectangular. First junction terminal portion 230 has thickness D1 at a portion of each first groove 232, thickness D1 is smaller than thickness D2 at a portion of each first junction 231.

Second bus bar 300 is formed by cutting out, from a conductive material such as a copper plate, an appropriate shape followed by bending. Second bus bar 300 is, therefore, a single structure including second electrode terminal portion 310, second relay portion 320, and second junction terminal portion 330.

Second electrode terminal portion 310 has a substantially rectangular flat plate shape elongated in the Y-axis direction, with end 310a on the negative X-axis side (the side of second relay portion 320) being raised one step in the Z-axis direction. The two corners of second electrode terminal portion 310 in the positive X-axis direction are formed into large arcs. At the end of second electrode terminal portion 310 in the positive X-axis direction, substantially semicircular notch 311 is formed at a central portion.

Second relay portion 320 provides a relay between second electrode terminal portion 310 and second junction terminal portion 330. Second relay portion 320 has a substantially rectangular flat plate shape elongated in the Y-axis direction and extends perpendicularly to second electrode terminal portion 310 in the positive Z-axis direction from the end of second electrode terminal portion 310 in the negative X-axis direction. At the positive Y-axis side end and the negative Y-axis side end of second relay portion 320, second protrusion pieces 321 are formed, protruding in the positive Y-axis direction and the negative Y-axis direction, respectively.

Second junction terminal portion 330 has a substantially rectangular flat plate shape elongated in the Y-axis direction and extends in the positive X-axis direction perpendicularly to second relay portion 320 from the end of second relay portion 320 in the positive Z-axis direction. On an inner portion of the surface of second junction terminal portion 330, second junctions 331 to which welding is performed when an external terminal is joined are provided at two positions arranged in the Y-axis direction. On the surface of second junction terminal portion 330, as a designation section indicating the region of each second junction 331, substantially rectangular annular second groove 332 is provided, which indicates a boundary between the region of each second junction 331 and other regions.

As shown in FIG. 8B, second groove 332 has, for example, a V-shaped cross-section. Second groove 332 may have a cross-sectional shape other than V-shaped, such as semicircular, U-shaped, or rectangular. Second junction terminal portion 330 has thickness D3 at a portion of each second groove 332 that is smaller than thickness D4 at a portion of each second junction 331.

Insulation member 400 is formed of a material with electrical insulation, such as polyphenylene sulfide (PPS), and has a substantially rectangular flat plate shape elongated in the Y-axis direction. On first surface 400a on the negative X-axis side and second surface 400b on the positive X-axis side of insulation member 400, substantially rectangular first recess 410 and second recess 420 are respectively formed, which are elongated in the Y-axis direction and recessed relative to these surfaces. In first recess 410, at the positive Y-axis side end, passage 411 extending to the negative Z-axis side end of insulation member 400 is provided.

Insulation member 400 is provided with holding portions 430 at both ends in the Y-axis direction. Each holding portion 430 has first fitting groove 431, which opens in the negative Z-axis direction and the Y-axis direction, on the side of first surface 400a, and second fitting groove 432, which opens in the positive Z-axis direction and the Y-axis direction, on the side of second surface 400b. Furthermore, at the positive Z-axis end of insulation member 400, eave portion 440 extending in the negative X-axis direction is provided.

In capacitor element module 10, first electrode terminal portion 210 of first bus bar 200 contacts first electrodes 110 of four capacitor elements 100 from the negative Z-axis side. First electrode terminal portion 210 and four first electrodes 110 are joined by joining methods such as welding and soldering. Thus, first bus bar 200 is electrically connected to four first electrodes 110.

Second electrode terminal portion 310 of second bus bar 300 contacts second electrodes 120 of four capacitor elements 100 from the positive Z-axis side. There is a gap between end 310a of second electrode terminal portion 310 and second electrode 120. Second electrode terminal portion 310 and four second electrodes 120 are joined by joining methods such as welding and soldering. Thus, second bus bar 300 is electrically connected to four second electrodes 120.

First relay portion 220 of first bus bar 200, serving as an opposing portion included in first bus bar 200, faces first plane face 131 of circumferential surface 130 of each of two capacitor elements 100 on the negative X-axis side from the negative X-axis side across the entire area between first electrode 110 and second electrode 120. Distal end surface 221a of each of two protrusions 221 on the positive Y-axis side of first relay portion 220 abuts first plane face 131 of capacitor element 100 on the positive Y-axis side at a position closer to first electrode 110 than to second electrode 120. Similarly, distal end surface 221a of each of two protrusions 221 on the negative Y-axis side of first relay portion 220 abuts first plane face 131 of capacitor element 100 on the negative Y-axis side at a position closer to first electrode 110 than to second electrode 120.

The portion on the positive Z-axis side of insulation member 400 is interposed between and in contact with first relay portion 220 of first bus bar 200 and second relay portion 320 of second bus bar 300. Also, the portion on the negative Z-axis side of insulation member 400 is interposed between and in contact with first relay portion 220 of first bus bar 200 and first plane face 131 of each of two capacitor elements 100 on the negative X-axis side. Thus, insulation between first relay portion 220 and both second relay portion 320 and second electrode 120 is ensured.

Thickness D5 of insulation member 400 is made equal to protrusion length D6 of each of four protrusions 221 of first relay portion 220 (see FIG. 2). Thus, first plane face 131 of each of two capacitor elements 100 is parallel to first relay portion 220. Uniform gap S of a constant width (width for thickness D5 and protrusion length D6) is ensured between first plane face 131 of each of two capacitor elements 100 and first relay portion 220. By maintaining a constant distance between two capacitor elements 100 and first relay portion 220, that is, by reducing variations in this distance, the electrical characteristics of film capacitor 1 become less likely to vary.

First protrusion piece 222 of first relay portion 220 is fitted into first fitting groove 431 of holding portion 430 of insulation member 400 from the negative Z-axis side, and first junction terminal portion 230 abuts eave portion 440 of insulation member 400 from the negative Z-axis side. Second protrusion piece 321 of second relay portion 320 is fitted into second fitting groove 432 of holding portion 430 of insulation member 400 from the negative Z-axis side, and second junction terminal portion 330 abuts holding portion 430 from the positive Z-axis side. Thus, first bus bar 200, second bus bar 300, and insulation member 400 are less likely to separate in the X-axis direction, the Y-axis direction, and the Z-axis direction.

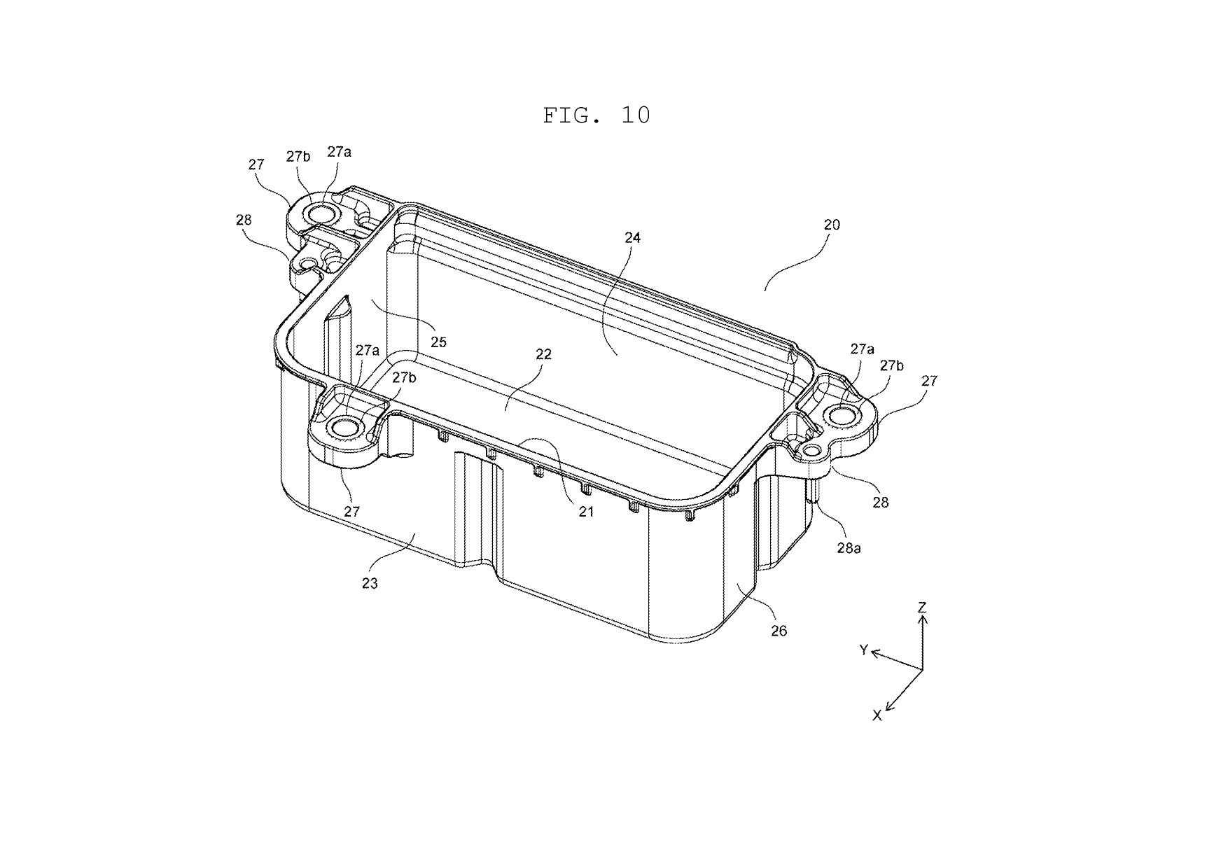

FIG. 10 is a perspective view of case 20.

Case 20 is made of a resin material, for example, a thermoplastic resin such as polyphenylene sulfide (PPS). Case 20 may also be made of a thermosetting resin such as epoxy resin.

Case 20 has a substantially rectangular box shape and includes substantially rectangular opening 21, substantially rectangular bottom portion 22 facing opening 21, substantially rectangular first side wall 23 and second side wall 24 extending toward opening 21 (in the positive Z-axis direction) from both ends of bottom portion 22 on the X-axis direction side and facing each other, and rectangular third side wall 25 and fourth side wall 26 extending toward opening 21 (in the positive Z-axis direction) from both ends of bottom portion 22 on the Y-axis direction side and facing each other.

Mounting tab 27 is provided on each of first side wall 23, third side wall 25, and fourth side wall 26. Each mounting tab 27 has insertion hole 27a. Metal collar 27b is fitted into insertion hole 27a for increasing hole strength. Furthermore, positioning tab 28 is provided on each of third side wall 25 and fourth side wall 26. Each positioning tab 28 has positioning pin 28a protruding toward bottom portion 22. When film capacitor 1 is installed at an installation portion of an external device, mounting tab 27 is fixed to the installation portion by bolts or the like. At this time, positioning pin 28a is inserted into a positioning hole provided in the installation portion to position film capacitor 1 relative to the installation portion.

Inside case 20, capacitor element module 10 is arranged in a manner that first electrodes 110 of four capacitor elements 100 face bottom portion 22 of case 20. First relay portion 220 of first bus bar 200 extends along second side wall 24 of case 20 from the side of bottom portion 22 toward opening 21, is led out from casting surface 31 of filler resin 30 to the outside of filler resin 30, and first junction terminal portion 230 of first bus bar 200 is exposed from filler resin 30. Similarly, second relay portion 320 of second bus bar 300 is led out from casting surface 31 to the outside of filler resin 30, and second junction terminal portion 330 of second bus bar 300 is exposed from filler resin 30.

During the assembly of film capacitor 1, first, a housing step is performed to house capacitor element module 10 inside case 20 through opening 21. Capacitor element module 10 is positioned at a predetermined position inside case 20 by a positioning jig.

Next, a resin injection step is performed to inject liquid-phase filler resin 30 into case 20 through opening 21, filling case 20 up to a position near opening 21. First junction terminal portion 230 of first bus bar 200 and second junction terminal portion 330 of second bus bar 300 are exposed from a liquid surface of liquid-phase filler resin 30, which becomes casting surface 31 after curing.

Between first plane face 131 of each of two capacitor elements 100 and first relay portion 220 of first bus bar 200 on the negative X-axis side, gap S of a constant width is ensured by insulation member 400 and four protrusions 221. Therefore, injected filler resin 30 easily enters gap S, fully filling gap S and making it less likely for air to remain in gap S. In particular, not only does filler resin 30 enter gap S from both sides in the Y-axis direction of first relay portion 220, but also, as indicated by the dashed arrows in FIG. 2, filler resin 30 enters through the gap between end 310a of second electrode terminal portion 310 of second bus bar 300 and second electrode 120 of each of two capacitor elements 100 on the negative X-axis side, as well as through the gap between two second electrodes 120, making it more likely for filler resin 30 to reach gap S.

Moreover, injected filler resin 30 enters first recess 410 and second recess 420 of insulation member 400, and first recess 410 and second recess 420 are filled with filler resin 30.

Furthermore, in capacitor element module 10, notch 211 of first electrode terminal portion 210 of first bus bar 200 and notch 311 of second electrode terminal portion 310 of second bus bar 300 are provided to align with a space formed at a central portion of four capacitor elements 100 (see FIGS. 3 and 4). Therefore, injected filler resin 30 is more likely to reach between capacitor element module 10 and bottom portion 22 of case 20 through two notches 211, 311 and the space at the central portion.

Once case 20 is filled with filler resin 30, a resin curing step is performed to heat the inside of case 20, thereby heating filler resin 30. Thus, filler resin 30 is cured in case 20. Filler resin 30 serves as the exterior body that covers capacitor element module 10.

Thus, as shown in FIG. 1, film capacitor 1 is completed.

Circumferential surface 130 of each of two capacitor elements 100 on the negative X-axis side and first relay portion 220 are joined with filler resin 30 present in gap S therebetween. At this time, a constant thickness is ensured for filler resin 30 present in gap S, and thus, peeling is less likely to occur between circumferential surface 130 of each capacitor element 100 and filler resin 30 or between first relay portion 220 and filler resin 30. Also, since gap S is less likely to become narrower, cavities (voids) are less likely to occur within filler resin 30 present in gap S. Therefore, deterioration of moisture resistance due to moisture entering peeled portions or cavities is less likely to occur, and thus, the moisture resistance of film capacitor 1 can be improved. Furthermore, first relay portion 220 and insulation member 400 are joined with filler resin 30 in first recess 410, and second relay portion 320 and insulation member 400 are joined with filler resin 30 in second recess 420. Thus, moisture is less likely to enter between first relay portion 220 and insulation member 400 and between second relay portion 320 and insulation member 400, further enhancing the moisture resistance of film capacitor 1.

During the resin injection step, when liquid-phase filler resin 30 is injected into case 20, numerous air bubbles may be generated in liquid-phase filler resin 30 inside case 20 due to the entrainment of air. There is a risk that these air bubbles may burst near a liquid surface, causing resin to scatter from the liquid surface, and the scattered resin may adhere to first junction 231 of first junction terminal portion 230 and second junction 331 of second junction terminal portion 330, which are near the liquid surface. Furthermore, there is a risk that during the various steps until film capacitor 1 is completed, foreign substances such as dust may adhere to first junction 231 and second junction 331.

When external terminals are joined to first junction terminal portion 230 and second junction terminal portion 330, welding is performed within the regions of first junction 231 and second junction 331. Therefore, there is a risk that in completed film capacitor 1, when foreign substances such as resin and dust are adhering to first junction 231 or second junction 331, the foreign substances may interfere with welding.

Accordingly, in completed film capacitor 1, an inspection is performed to check whether foreign substances are adhering to first junction 231 or second junction 331. In film capacitor 1 of the present exemplary embodiment, on the surface of first junction terminal portion 230, the boundary between the region of first junction 231 and other regions is indicated by first groove 232, which serves as the designation section. Similarly, on the surface of second junction terminal portion 330, the boundary between the region of second junction 331 and other regions is indicated by second groove 332, which serves as the designation section. Therefore, an inspector can easily grasp first junction 231 and second junction 331 and can easily perform inspections for the presence or absence of foreign substance adhesion. Thus, the inspector can easily detect adhesion of foreign substances, especially resin, on first junction 231 and second junction 331.

Film capacitor 1 is mounted on the external device. The external device is provided with external terminal T1 corresponding to first junction terminal portion 230 of first bus bar 200 and external terminal T2 corresponding to second junction terminal portion 330 of second bus bar 300. External terminal T1 is joined to first junction terminal portion 230 by welding, and external terminal T2 is joined to second junction terminal portion 330 by welding.

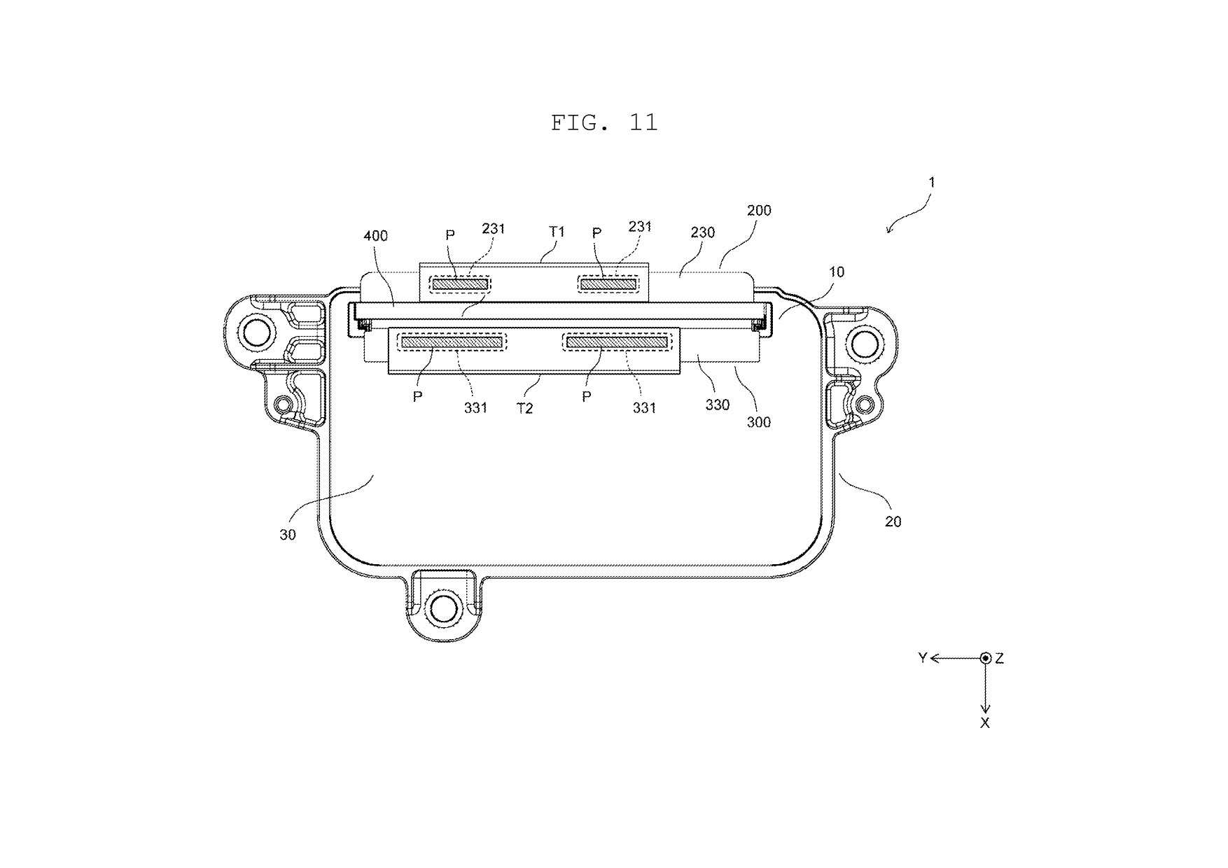

FIG. 11 is a plan view of film capacitor 1 in a state where external terminals T1, T2 are joined to first junction terminal portion 230 and second junction terminal portion 330.

External terminal T1 is overlapped onto the surface of first junction terminal portion 230 in a manner of covering two first junctions 231. A joining surface of external terminal T1 that contacts first junction terminal portion 230 is flat. Similarly, external terminal T2 is overlapped onto the surface of second junction terminal portion 330 in a manner of covering two second junctions 331. A joining surface of external terminal T2 that contacts second junction terminal portion 330 is flat.

Welding using welding equipment (laser welding, resistance welding, etc.) is performed within the regions of each first junction 231 and each second junction 331. Thus, external terminal T1 is joined to first junction terminal portion 230, and external terminal T2 is joined to second junction terminal portion 330.

Actual welded portion P has a shape elongated in the longitudinal direction (Y-axis direction) of first junction terminal portion 230 and second junction terminal portion 330. Therefore, to correspond to the shape of welded portion P, each first junction 231 and each second junction 331 have a substantially rectangular shape. Also, there is a risk that the position of welded portion P may slightly deviate due to assembly tolerances and component tolerances, etc. of film capacitor 1. Therefore, considering an amount of position deviation of welded portion P, the sizes of each first junction 231 and each second junction 331 are made larger than the size of welded portion P. Note that if the shape of welded portion P is changed, the shapes of each first junction 231 and each second junction 331 may also be changed accordingly.

The designation section that indicates each first junction 231 is first groove 232, which does not protrude from the surface of first junction terminal portion 230. Therefore, the contact of the joining surface of external terminal T1 with the surface of first junction terminal portion 230 is not hindered by the designation section. Moreover, first junction terminal portion 230 has thickness D1 at a portion of each first groove 232, thickness D1 is smaller than thickness D2 at a portion of each first junction 231 (see FIG. 8A). Therefore, since heat is less likely to propagate in the portion of each first groove 232, the heat generated at each first junction 231 during welding is less likely to escape from each first junction 231. Thus, welding can be performed more efficiently at each first junction 231.

Similarly, the designation section that indicates each second junction 331 is second groove 332, which does not protrude from the surface of second junction terminal portion 330. Therefore, the contact of the joining surface of external terminal T2 with the surface of second junction terminal portion 330 is not hindered by the designation section. Moreover, second junction terminal portion 330 has thickness D3 at a portion of each second groove 332, thickness D3 is smaller than thickness D4 at a portion of each second junction 331 (see FIG. 8B). Therefore, since heat is less likely to propagate in the portion of each second groove 332, the heat generated at each second junction 331 during welding is less likely to escape from each second junction 331. Thus, welding can be performed more efficiently at each second junction 331.

Note that since first junction 231 and second junction 331 are indicated by first groove 232 and second groove 332, respectively, it is also possible for the welding equipment to identify the regions of first junction 231 and second junction 331 through image recognition and perform welding accordingly.

### Effects of first exemplary embodiment

The first exemplary embodiment described above achieves the following effects.

Film capacitor 1 includes: capacitor element 100 that includes first electrode 110 formed on one end surface, second electrode 120 formed on another end surface, and circumferential surface 130 connecting first electrode 110 and second electrode 120; first bus bar 200 and second bus bar 300 that are connected respectively to first electrode 110 and second electrode 120; case 20 that houses capacitor element 100; and filler resin 30 that is filled inside case 20 and used to embed capacitor element 100 and a part of first bus bar 200 and second bus bar 300. Circumferential surface 130 includes first plane face 131 (plane face), and first bus bar 200 includes flat-plate-shaped first relay portion 220 (opposing portion) that faces the plane face. First relay portion 220 includes protrusions 221 that protrude toward first plane face 131 and abut first plane face 131.

According to this configuration, it is possible to maintain a constant width of gap S between first plane face 131 of circumferential surface 130 of capacitor element 100 and first relay portion 220 of first bus bar 200 by the interposition of protrusions 221 in gap S. Therefore, a constant thickness is ensured for filler resin 30 present in gap S, and thus, peeling is less likely to occur between circumferential surface 130 and filler resin 30 or between first relay portion 220 and filler resin 30. Moreover, since gap S is less likely to become narrow, liquid-phase filler resin 30 is more likely to flow into gap S, and cavities are less likely to occur within filler resin 30 present in gap S. Therefore, deterioration of moisture resistance due to moisture entering peeled portions or cavities is less likely to occur, and thus, the moisture resistance of film capacitor 1 can be improved (Effect 1).

Furthermore, since variations in the distance between circumferential surface 130 of capacitor element 100 and first relay portion 220 of first bus bar 200 are less likely to occur, variations in the electrical characteristics of film capacitor 1 are less likely to occur (Effect 2).

Furthermore, first relay portion 220 faces first plane face 131 across the area between first electrode 110 and second electrode 120. Insulation member 400 is interposed between first plane face 131 and first relay portion 220 on the side of second electrode 120.

According to this configuration, not only protrusions 221 but also insulation member 400 can maintain a constant width of gap S between first plane face 131 and first relay portion 220 (Effect 3).

Furthermore, protrusions 221 are provided on first relay portion 220 at positions closer to first electrode 110 than to second electrode 120.

According to this configuration, protrusions 221 and insulation member 400 can be arranged in a balanced manner in the direction in which first electrode 110 and second electrode 120 are arranged, and thus, it becomes easier to maintain a constant width of gap S throughout the entire area between first plane face 131 and first relay portion 220 (Effect 4).

Furthermore, case 20 includes opening 21, bottom portion 22 facing opening 21, and second side wall 24 (side wall) extending from the end of bottom portion 22 toward opening 21. Capacitor element 100 is arranged inside case 20 in a manner that first electrode 110 faces bottom portion 22. First relay portion 220 extends along second side wall 24 inside case 20.

In a configuration where capacitor element 100 is arranged inside case 20 in a manner that first electrode 110 faces bottom portion 22, and first relay portion 220 extends along second side wall 24 inside case 20, gap S between first plane face 131 and first relay portion 220 is located relatively far from opening 21 of case 20, and thus, compared to a configuration where gap S is closer to opening 21, filler resin 30 is less likely to enter gap S.

However, according to this configuration, when gap S between first plane face 131 and first relay portion 220 is located relatively far from opening 21 of case 20, the interposition of protrusions 221 in gap S makes it easier for filler resin 30 to enter gap S, and thus, it is possible to effectively suppress the occurrence of cavities within filler resin 30 present in gap S (Effect 5).

Furthermore, distal end surface 221a, which abuts first plane face 131, of protrusion 221 is flat. According to this configuration, a stress applied to first plane face 131 due to the abutting contact of protrusion 221 is alleviated, making capacitor element 100 less susceptible to damage (Effect 6).

Furthermore, first relay portion 220 is parallel to first plane face 131.

According to this configuration, the thickness of filler resin 30 present in gap S between first plane face 131 and first relay portion 220 can be made uniform, preventing filler resin 30 from becoming partially thin.

Furthermore, thickness D5 of insulation member 400 is made equal to protrusion length D6 of protrusion 221.

According to this configuration, first relay portion 220 and first plane face 131 are more likely to be parallel in the direction in which first electrode 110 and second electrode 120 are arranged (Effect 7).

Furthermore, first relay portion 220 includes a plurality (two) of protrusions 221 arranged in a direction perpendicular to the direction in which first electrode 110 and second electrode 120 are arranged.

According to this configuration, protrusions 221 abut first plane face 131 at a plurality of locations (two locations) in the direction perpendicular to the direction in which first electrode 110 and second electrode 120 are arranged, and thus, first relay portion 220 and first plane face 131 are more likely to be parallel (Effect 8).

### SECOND EXEMPLARY EMBODIMENT

Film capacitor 2 according to a second exemplary embodiment is to be described.

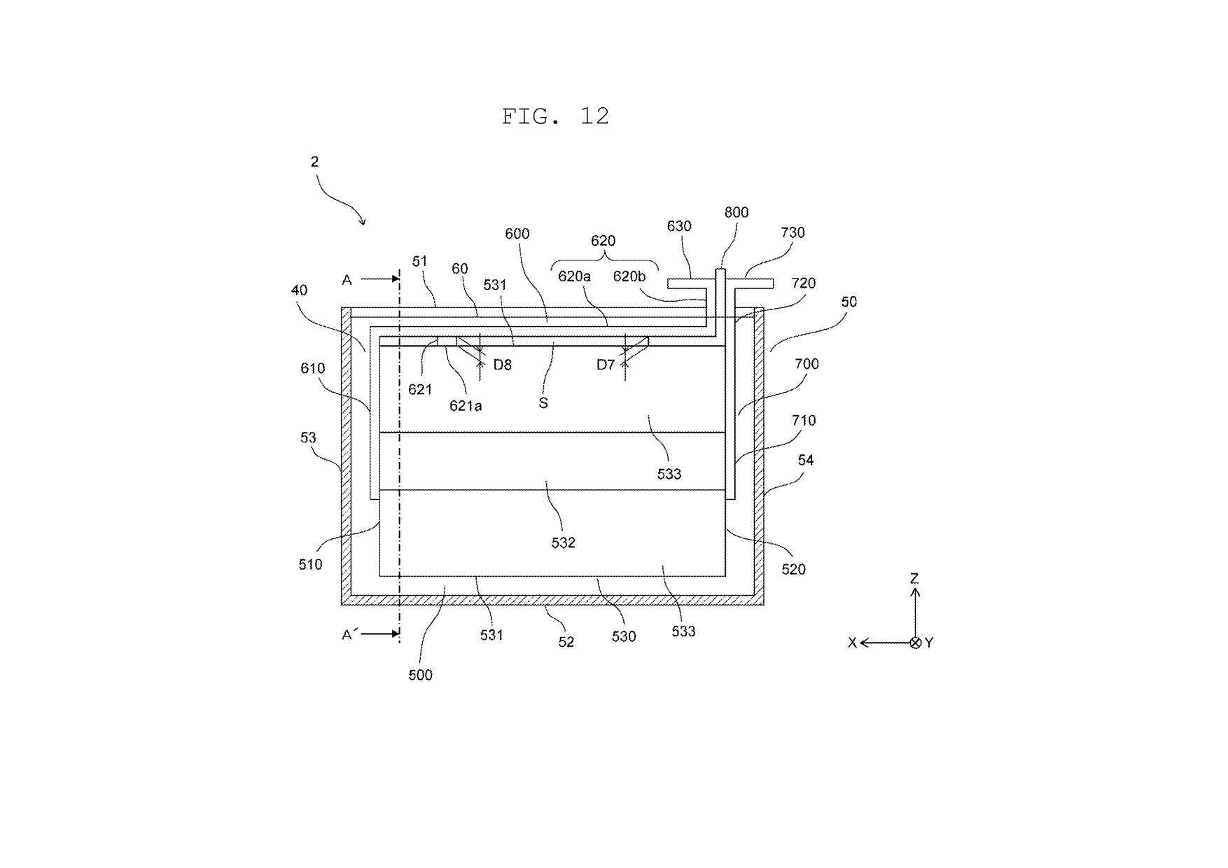

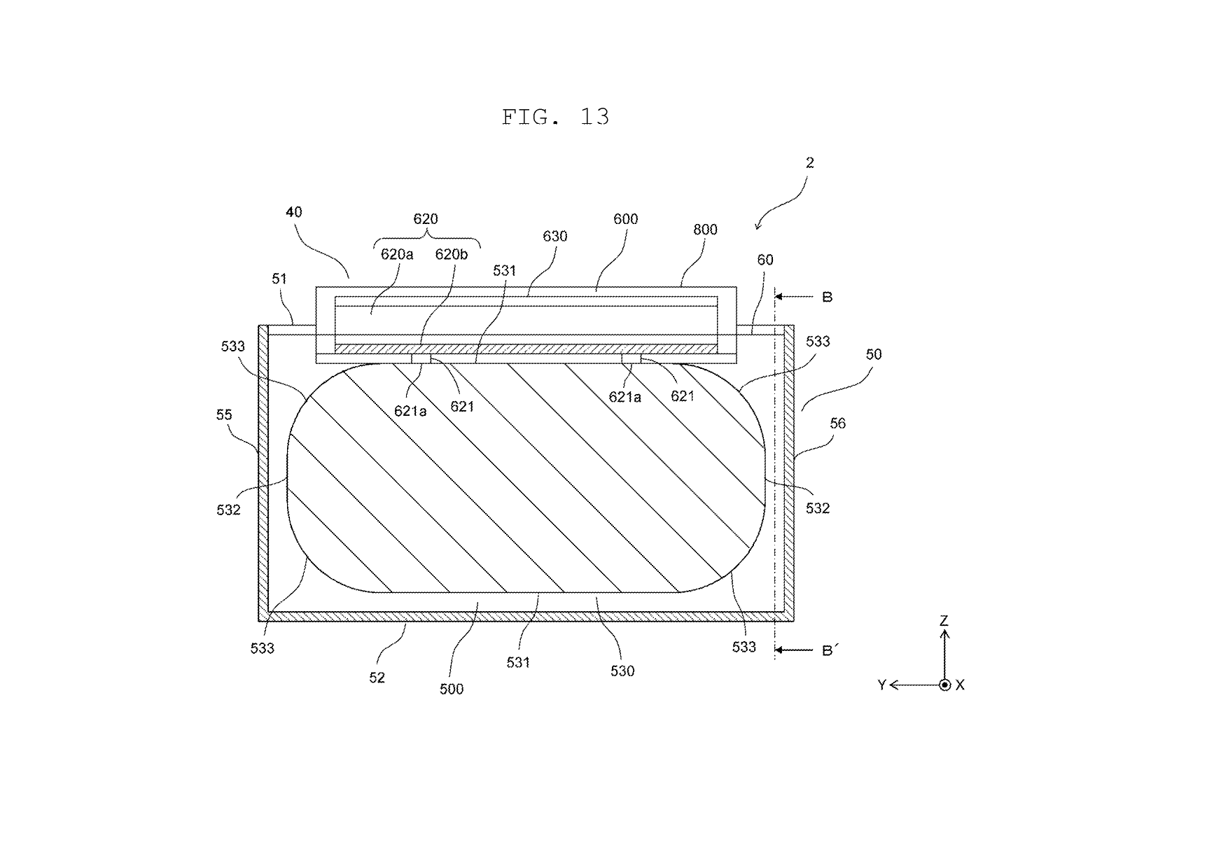

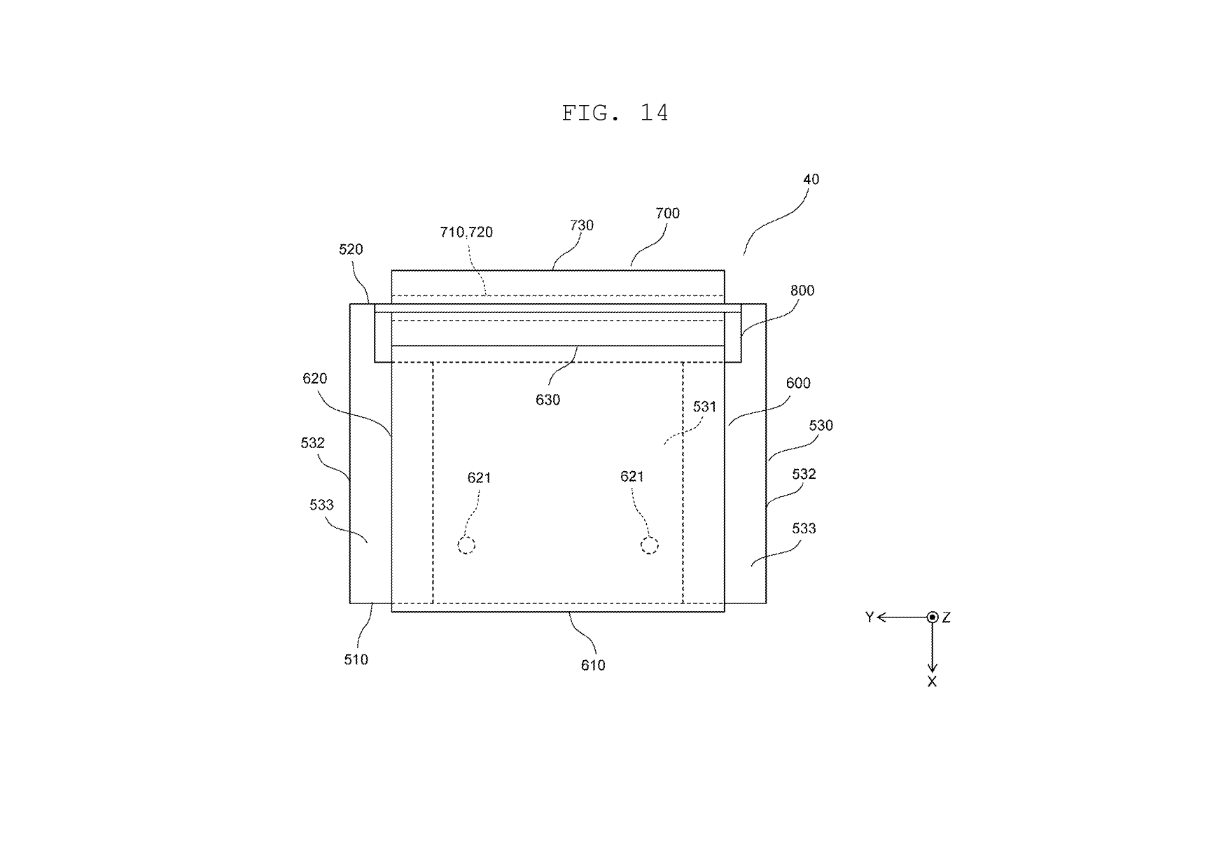

FIG. 12 and FIG. 13 are cross-sectional views of film capacitor 2. In FIG. 12, film capacitor 2 cut along line B-B' in FIG. 13 is shown. In FIG. 13, film capacitor 2 cut along line A-A' in FIG. 12 is shown. FIG. 14 is a plan view of capacitor element module 40. Note that in FIGS. 12 and 13, for convenience, filler resin 60 is shown as transparent.

Film capacitor 2 includes capacitor element module 40, case 50, and filler resin 60. Capacitor element module 40 is housed in case 50, and case 50 is filled with filler resin 60.

Filler resin 60 is a thermosetting resin such as epoxy resin, and filler resin 60 is injected into case 50 in a liquid-phase state and cured by heating to cover capacitor element module 40 inside case 50. A portion of capacitor element module 40 embedded in filler resin 60 is protected from moisture and impact by case 50 and filler resin 60.

Capacitor element module 40 includes capacitor element 500, first bus bar 600, second bus bar 700, and insulation member 800.

The configuration of capacitor element 500 is the same as that of capacitor element 100 and includes first electrode 510, second electrode 520, and circumferential surface 530. Circumferential surface 530 includes two first plane faces 531, two second plane faces 532, and four arc surfaces 533.

First bus bar 600 is formed by cutting out, from a conductive material such as a copper plate, an appropriate shape followed by bending. First bus bar 600 is, therefore, a single structure including first electrode terminal portion 610, first relay portion 620, and first junction terminal portion 630.

First electrode terminal portion 610 has a substantially rectangular flat plate shape elongated in the Y-axis direction. First electrode terminal portion 610 contacts first electrode 510 of capacitor element 500 from the positive X-axis side. First electrode terminal portion 610 and first electrode 510 are joined by joining methods such as welding and soldering. Thus, first bus bar 600 is electrically connected to first electrode 510.

First relay portion 620 provides a relay between first electrode terminal portion 610 and first junction terminal portion 630. First relay portion 620 has a substantially rectangular flat plate shape elongated in the Y-axis direction and includes first portion 620a extending in the negative X-axis direction from the end of first electrode terminal portion 610 in the positive Z-axis direction, and second portion 620b extending in the positive Z-axis direction from the end of first portion 620a in the negative X-axis direction. As the opposing portion included in first bus bar 600, first relay portion 620 faces first plane face 531 of circumferential surface 530 of capacitor element 500 from the negative X-axis side across the area between first electrode 510 and second electrode 520.

On first portion 620a of first relay portion 620, at positions closer to first electrode 510 than to second electrode 520 on the surface on the negative Z-axis side, two protrusions 621 are provided in a manner of being arranged in the Y-axis direction. Two protrusions 621 have a flat, substantially cylindrical shape, protrude from first relay portion 620 toward first plane face 531 of circumferential surface 530 of capacitor element 500, and abut first plane 531. Distal end surface 621a, which abuts first plane face 531, of each protrusion 621 has a flat shape.

First junction terminal portion 630 has a substantially rectangular flat plate shape elongated in the Y-axis direction and extends in the positive X-axis direction from the end of second portion 620b of first relay portion 620 in the positive Z-axis direction.

Second bus bar 700 is formed by cutting out, from a conductive material such as a copper plate, an appropriate shape followed by bending. Second bus bar 700 is, therefore, a single structure including second electrode terminal portion 710, second relay portion 720, and second junction terminal portion 730.

Second electrode terminal portion 710 has a substantially rectangular flat plate shape elongated in the Y-axis direction. Second electrode terminal portion 710 contacts second electrode 520 of capacitor element 500 from the negative X-axis side. Second electrode terminal portion 710 and second electrode 520 are joined by joining methods such as welding and soldering. Thus, second bus bar 700 is electrically connected to second electrode 520.

Second relay portion 720 provides a relay between second electrode terminal portion 710 and second junction terminal portion 730. Second relay portion 720 has a substantially rectangular flat plate shape elongated in the Y-axis direction and extends in the positive Z-axis direction continuously from second electrode terminal portion 710.

Second junction terminal portion 730 has a substantially rectangular flat plate shape elongated in the Y-axis direction and extends in the negative X-axis direction from the end of second relay portion 720 in the positive Z-axis direction.

Insulation member 800 is formed of a material with electrical insulation, such as polyphenylene sulfide (PPS), and has a flat plate shape with an L-shaped cross-section elongated in the Y-axis direction. Insulation member 800 is interposed between first relay portion 620 and second relay portion 720 on the side of second electrode 520, and is also interposed between first relay portion 620 and first plane face 531 of circumferential surface 530 of capacitor element 500. Thus, insulation between first relay portion 620 and both second relay portion 720 and second electrode 520 is ensured.

Thickness D7 of insulation member 800 is made equal to protrusion length D8 of two protrusions 621 of first relay portion 620 (see FIG. 12A). Thus, first plane face 531 of capacitor element 500 is parallel to first relay portion 620. Uniform gap S of a constant width (width for thickness D7 and protrusion length D8) is ensured between first plane face 531 and first relay portion 620. By maintaining a constant distance between capacitor element 500 and first relay portion 620, that is, by reducing variations in this distance, the electrical characteristics of film capacitor 2 become less likely to vary.

Case 50 is made of a resin material, for example, a thermoplastic resin such as polyphenylene sulfide (PPS). Case 50 has a substantially rectangular box shape and includes substantially rectangular opening 51, substantially rectangular bottom portion 52 facing opening 51, substantially rectangular first side wall 53 and second side wall 54 extending toward opening 51 (in the positive Z-axis direction) from both ends of bottom portion 52 on the X-axis direction side and facing each other, and rectangular third side wall 55 and fourth side wall 56 extending toward opening 51 (in the positive Z-axis direction) from both ends of bottom portion 52 on the Y-axis direction side and facing each other.

Inside case 50, capacitor element module 40 is arranged in a manner that first electrode 510 and second electrode 520 of capacitor element 500 face first side wall 53 and second side wall 54 of case 50, respectively. First relay portion 620 of first bus bar 600 extends along opening 51 of case 50 from the side of first side wall 53 toward second side wall 54, then bends and is led out to the outside of filler resin 60, and first junction terminal portion 630 of first bus bar 600 is exposed from filler resin 60. Moreover, second relay portion 720 of second bus bar 700 is led out to the outside of filler resin 60, and second junction terminal portion 730 of second bus bar 700 is exposed from filler resin 60.

Circumferential surface 530 of capacitor element 500 and first relay portion 620 are joined with filler resin 60 present in gap S therebetween. At this time, a constant thickness is ensured for filler resin 60 present in gap S, and thus, peeling is less likely to occur between circumferential surface 530 of each capacitor element 500 and filler resin 60 or between first relay portion 620 and filler resin 60. Also, since gap S is less likely to become narrower, cavities are less likely to occur within filler resin 60 present in gap S. Therefore, deterioration of moisture resistance due to moisture entering peeled portions or cavities is less likely to occur, and thus, the moisture resistance of film capacitor 2 can be improved.

Note that in film capacitor 2 of the present exemplary embodiment, gap S between circumferential surface 530 of capacitor element 500 and first relay portion 620 is located closer to opening 51 of case 50 compared to film capacitor 1 of the first exemplary embodiment.

Film capacitor 2 is mounted on the external device. Similar to the first exemplary embodiment, external terminal T1 is joined to first junction terminal portion 630 by welding, and external terminal T2 is joined to second junction terminal portion 730 by welding.

### Effects of second exemplary embodiment

According to the second exemplary embodiment, similar effects as Effect 1 to Effect 4 and Effect 6 to Effect 8 described in the first exemplary embodiment can be achieved.

### MODIFICATION

Although the exemplary embodiments of the present disclosure have been described above, the present disclosure is not limited to the above exemplary embodiments, and application examples of the present disclosure can be variously modified in addition to the above exemplary embodiments.

For example, in the first exemplary embodiment or the second exemplary embodiment, first relay portion 220, 620 of first bus bar 200, 600 has two protrusions 221, 621 for one capacitor element 100, 500, but first relay portion 220, 620 may have one or three or more protrusions 221, 621. Note that it is desirable that when one protrusion 221, 621 is provided, protrusion 221, 621 is formed in a shape elongated in the direction perpendicular to the direction in which first electrode 110, 510 and second electrode 120, 520 are arranged (Y-axis direction), for example, formed in an oblong cylindrical shape.

Furthermore, in the first exemplary embodiment or the second exemplary embodiment, protrusion 221, 621 has a cylindrical shape. However, protrusion 221, 621 may be of any shape, such as a prismatic shape.

Furthermore, in the first exemplary embodiment or the second exemplary embodiment, protrusion 221, 621 and insulation member 400, 800 are interposed in gap S between first plane face 131, 531 of capacitor element 100, 500 and first relay portion 220, 620 of first bus bar 200, 600. However, a configuration in which only protrusion 221, 621 is interposed in gap S may be adopted.

Furthermore, in the first exemplary embodiment or the second exemplary embodiment, distal end surface 221a, 621a of protrusion 221, 621, which abuts first plane face 131, 531 of capacitor element 100, 500, is formed as a flat face, but distal end surface 221a, 621a may be formed as a surface other than a flat face, such as an arc surface.

Furthermore, the configurations of first bus bar 200, 600 and second bus bar 300, 700 are not limited to the configurations shown in the first exemplary embodiment or the second exemplary embodiment, and may be any configuration.

In the above first exemplary embodiment, film capacitor 1 includes four capacitor elements 100. In the above second exemplary embodiment, film capacitor 2 includes one capacitor element 500. However, the number of capacitor element 100, 500 can be changed as appropriate.

Further, in the first exemplary embodiment or the second exemplary embodiment, capacitor element 100, 500 is formed by stacking two metallized films each with aluminum vapor-deposited on a dielectric film, and winding or laminating the stacked metallized films. Alternatively, capacitor element 100, 500 may be formed by stacking a metallized film with aluminum vapor-deposited on both surfaces of a dielectric film, and an insulation film, and winding or laminating the metallized film and the insulation film.

In the first exemplary embodiment or the second exemplary embodiment, film capacitor 1, 2 is cited as an example of the capacitor of the present disclosure. However, the present disclosure can also be applied to capacitors other than film capacitor 1, 2.

In addition, various modifications can be made to the exemplary embodiments of the present disclosure as appropriate within the scope of the technical idea recited in the claims.

### Supplementary Note

The above description of the exemplary embodiments discloses the following techniques.

### Technique 1

A capacitor includes: a capacitor element that includes a first electrode disposed on one end surface of the capacitor element, a second electrode disposed on another end surface of the capacitor element, and a circumferential surface connecting the first electrode to the second electrode; a first bus bar and a second bus bar that are connected to the first electrode and the second electrode, respectively; a case that houses the capacitor element; and a filler resin in which the capacitor element, a part of the first bus bar, and a part of the second bus bar are embedded, the filler resin being filled inside the case, wherein: the circumferential surface includes a plane face, the first bus bar includes an opposing portion that has a flat-plate-shape and faces the plane face, and the opposing portion includes a protrusion that protrudes toward the plane face and abuts the plane face.

According to this technique, it is possible to maintain a constant width of a gap between the plane face on the circumferential surface of the capacitor element and the opposing portion of the first bus bar by an interposition of the protrusion in the gap. Therefore, a constant thickness is ensured for the filler resin present in the gap, and thus, peeling is less likely to occur between the circumferential surface and the filler resin or between the opposing portion and the filler resin. Moreover, since the gap is less likely to become narrow, the liquid-phase filler resin is more likely to flow into the gap, and cavities are less likely to occur within the filler resin present in the gap. Therefore, deterioration of moisture resistance due to moisture entering peeled portions or cavities is less likely to occur, and thus, the moisture resistance of the capacitor can be improved.

Furthermore, since variations in the distance between the circumferential surface of the capacitor element and the opposing portion of the first bus bar are less likely to occur, variations in the electrical characteristics of the capacitor are less likely to occur.

### Technique 2

The capacitor according to Technique 1, wherein: the opposing portion faces the plane face from the first electrode to the second electrode, and an insulation member is disposed between the plane face and the opposing portion at a side close to the second electrode.

According to this technique, not only the protrusion but also the insulation member can maintain a constant width of the gap between the plane face and the opposing portion.

### Technique 3

The capacitor according to Technique 2, wherein the protrusion is provided on the opposing portion at a position closer to the first electrode than to the second electrode.

According to this technique, the protrusion and the insulation member can be arranged in a balanced manner in a direction in which the first electrode and the second electrode are arranged, and thus, it becomes easier to maintain a constant width of the gap throughout an entire area between the plane face and the opposing portion.

### Technique 4

The capacitor according to Technique 3, wherein: the case includes an opening, a bottom portion facing the opening, and a side wall extending from an end of the bottom portion toward the opening, the capacitor element is arranged inside the case in a manner that the first electrode faces the bottom portion, and the opposing portion extends along the side wall inside the case.

In a configuration where the capacitor element is arranged inside the case in a manner that the first electrode faces the bottom portion, and the opposing portion extends along the side wall inside the case, the gap between the plane face and the opposing portion is located relatively far from the opening of the case, and thus, compared to a configuration where the gap is closer to the opening, the filler resin is less likely to enter the gap.

However, according to this technique, when the gap between the plane face and the opposing portion is located relatively far from the opening of the case, the interposition of the protrusion in the gap makes it easier for the filler resin to enter the gap, and thus, it is possible to effectively suppress occurrence of cavities within the filler resin present in the gap.

### Technique 5

The capacitor according to any one of Technique 1 to Technique 4, wherein the protrusion includes a flat surface that abuts the plane face.

According to this technique, a stress applied to the plane face due to the abutting contact of the protrusion is alleviated, making the capacitor element less susceptible to damage.

### Technique 6

The capacitor according to any one of Technique 1 to Technique 5, wherein the opposing portion is parallel to the plane face.

According to this technique, the thickness of the filler resin present in the gap between the plane face and the opposing portion can be made uniform, preventing the filler resin from becoming partially thin.

### Technique 7

The capacitor according to Technique 6, wherein a thickness of the insulation member is equal to a protrusion length of the protrusion.

According to this technique, the opposing portion and the plane face are more likely to be parallel in the direction in which the first electrode and the second electrode are arranged.

### Technique 8

The capacitor according to Technique 6 or Technique 7, wherein the opposing portion includes a plurality of protrusions arranged in a direction perpendicular to a direction of arranging the first electrode and the second electrode, the plurality of protrusions including the protrusion.

According to this technique, the protrusions abut the plane face at a plurality of locations in the direction perpendicular to the direction in which the first electrode and the second electrode are arranged, and thus, the opposing portion and the plane face are more likely to be parallel.

The present disclosure is useful for capacitors used for various electronic devices, electric devices, industrial devices, electric components of vehicles, and the like.

What is claimed is:

1. A capacitor comprising:
a capacitor element that includes a first electrode disposed on one end surface of the capacitor element, a second electrode disposed on another end surface of the capacitor element, and a circumferential surface connecting the first electrode to the second electrode;
a first bus bar and a second bus bar that are connected to the first electrode and the second electrode, respectively;
a case that houses the capacitor element; and
a filler resin in which the capacitor element, a part of the first bus bar, and a part of the second bus bar are embedded, the filler resin being filled inside the case, wherein:
the circumferential surface includes a plane face,
the first bus bar includes an opposing portion that has a flat-plate-shape and faces the plane face, and
the opposing portion includes a protrusion that protrudes toward the plane face and abuts the plane face.

2. The capacitor according to claim 1, wherein:
the opposing portion faces the plane face from the first electrode to the second electrode, and
an insulation member is disposed between the plane face and the opposing portion at a side close to the second electrode.

3. The capacitor according to claim 2, wherein
the protrusion is provided on the opposing portion at a position closer to the first electrode than to the second electrode.

4. The capacitor according to claim 3, wherein:
the case includes an opening, a bottom portion facing the opening, and a side wall extending from an end of the bottom portion toward the opening,
the capacitor element is arranged inside the case in a manner that the first electrode faces the bottom portion, and
the opposing portion extends along the side wall inside the case.

5. The capacitor according to claim 1, wherein
the protrusion includes a flat surface that abuts the plane face.

6. The capacitor according to claim 1, wherein
the opposing portion is parallel to the plane face.

7. The capacitor according to claim 6, wherein
a thickness of the insulation member is equal to a protrusion length of the protrusion.

8. The capacitor according to claim 6, wherein
the opposing portion includes a plurality of protrusions arranged in a direction perpendicular to a direction of arranging the first electrode and the second electrode, the plurality of protrusions including the protrusion.
